(19) United States
(12) Patent Application Publication
(10) Pub. No.: US 2005/0259524 A1
(43) Pub. Date: Nov. 24, 2005

(54) Clamp type multimedia recorder

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/851,194

(22) Filed: May 24, 2004

(51) Int. Cl. G11B 19/00

(52) U.S. Cl. 369/25.01; 369/29.02; 369/30.02

(57) ABSTRACT

A clamp type multimedia recorder includes a main body in which a recording unit and an audio device are arranged and a clamp the selectively attaches the main body to a document folder. The main body is selectively provided with liquid crystal display to display images, which upgrades document communication from a traditional two-dimensional stationary style to a three-dimensional active style of text, voice and image synchronous communication. The clamp type multimedia recorder provides a live-like face-to-face interactive communication that is exact, vivid and effective communication and allows for modification of the data recorded.

### FIELD OF THE INVENTION

The present invention generally relates to a combination of a multimedia recorder with a clamp, which allows a document transmitter to leave vivid audio/video messages, in the recorder, to a document receiver thereby enhancing dynamic interaction between the document transmitter and receiver.

### BACKGROUND OF THE INVENTION

Conventional paper documents are transmitted with the aid of a document file or document folder in which the documents are organized and contained. The document folder is then handed over by a document transmitter to a document receiver. Important messages regarding the transmission of document or the document itself can be orally discussed between the transmitter and the receiver. Often it is not possible or there is no chance for the document transmitter to talk to the document receiver. Thus, a note on which the messages are put down is attached to the documents by for example a paper clip. Or alternatively, an adhesive based notepaper is used, which can be directly adhered to the documents for leaving messages.

Such a conventional manner of message leaving, however, is simply written message in static and planar (two-dimensional) form. Often, the hand script of the message is hard to recognize by the document receivers, or the message is incorrectly written, both leading to misunderstanding of the message and improper communication between the document transmitter and the intended document receiver.

Thus, the present invention is aimed to provide a device that allows for messages to be left on a document in a dynamic and stereoscopic (three-dimensional) manner so as to overcome the drawbacks of the conventional message notes.

### SUMMARY OF THE INVENTION

A primary objective of the present invention is to provide a clamp type multimedia recorder comprising a clamp for attaching the recorder to a document file to upgrade document communication from a planar (two-dimensional) and static fashion of written texts to a stereoscopic (three-dimensional) and dynamic multimedia manner of audio/video messages.

Another objective of the present invention is provide a clamp type multimedia recorder comprising a liquid crystal display, which shows messages in both image and text for vivid communication between a transmitter and intended receivers.

A further object of the present invention is to provide a clamp type multimedia recorder comprising a clamp that attaches the device to a document folder to enhance convenience of use with a vivid video/audio display.

To achieve the above objectives, in accordance with the present invention, a clamp type multimedia recorder is provided, comprising a main body in which a recording unit and an audio device are arranged and a clamp attaching the main body to a document or a document folder. The main body is selectively provided with a liquid crystal display for displaying messages/images. The main body comprises two spaced arms defining therebetween a space for accommodating the clamp. Pivot connection is formed between the clamp and the arms whereby the main body can be selectively positioned at any desired orientation with respect to the clamp.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a clamp type multimedia recorder constructed in accordance with the present invention;

FIG. 2 an exploded view of the clamp type multimedia recorder of the present invention;

FIG. 3 is a perspective view showing an application of the clamp type multimedia recorder of the present invention in which the recorder is attached to a document by a clamp comprising in part the clamp type multimedia recorder;

FIG. 4 is similar to FIG. 3 but showing another way of using the clamp type multimedia recorder of the present invention;

FIG. 5 is a perspective view showing another application of the clamp type multimedia recorder of the present invention in which the recorder is attached to a document file;

FIG. 6 is a perspective view showing a further application of the clamp type multimedia recorder of the present invention in which the recorder is used as a stand-alone device;

FIG. 7 is a side elevational view of a clamp type multimedia recorder constructed in accordance with another embodiment of the present invention; and

FIG. 8 is a side elevational view of a clamp type multimedia recorder constructed in accordance with a further embodiment of the present invention.

### DETAILED DESCRIPTION OF THE PREFERRED EMBODIMENTS

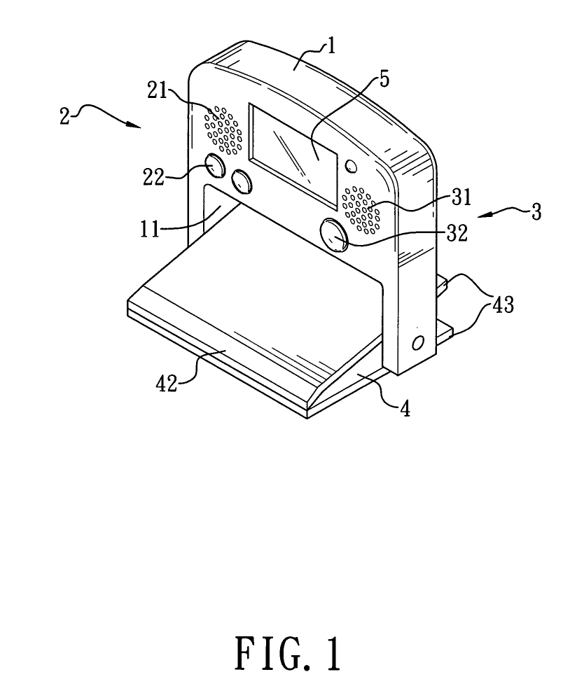

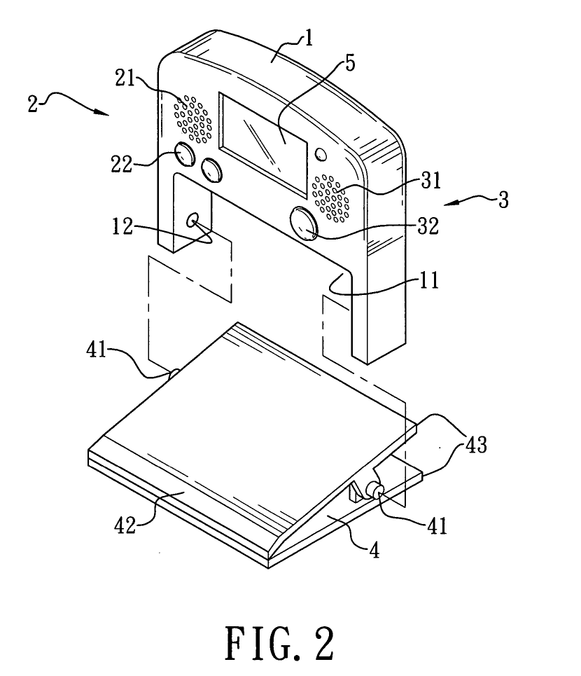

With reference to the drawings and in particular to FIGS. 1 and 2, a clamp type multimedia recorder constructed in accordance with the present invention comprises a main body 2 in which a recording unit 2 and an audio device 3 are arranged and a clamp 4 rotatably attached to the main body 2.

The recording unit 2 comprises a microphone 21 mounted to a front surface (not labeled) of the main body 2. Also provided on the front surface of the main body 2 is a recording knob or pushbutton 22, which comprises in part the recording unit 2.

The audio device 3 comprises a loud speaker 31 mounted in the main body 1 and gives off sounds through openings (not labeled) defined in the front surface or other portions of the main body 1. The audio device 3 also comprises a playing knob or pushbutton 32, providing a user with access to and control of the audio device 3.

The main body 1 comprises two side arms (not labeled), which in the embodiment illustrated, depend from a lower edge of the main body 1 and define a recess 11 therebetween. The side arms have opposing inside surfaces in which aligned pivot holes 12 are defined. The clamp 4 is received in the recess 11. The clamp 4 forms two pivot pins 41 on opposite sides thereof. The pivot pins 41 are rotatably received in the pivot holes 12 of the side arm of the main body 1 thereby rotatably attaching the clamp 4 to the main body 1. The clamp 4 comprises a front section forming clamping jaws 42 and a rear section forming a manual operation means 43, which can be operated/depressed by a user to open the clamping jaws 42 for receiving a document therein. The jaws 42 may be spring-biased.

The main body 1 selectively comprises a display, such as liquid crystal display 5, which allows for display of video messages.

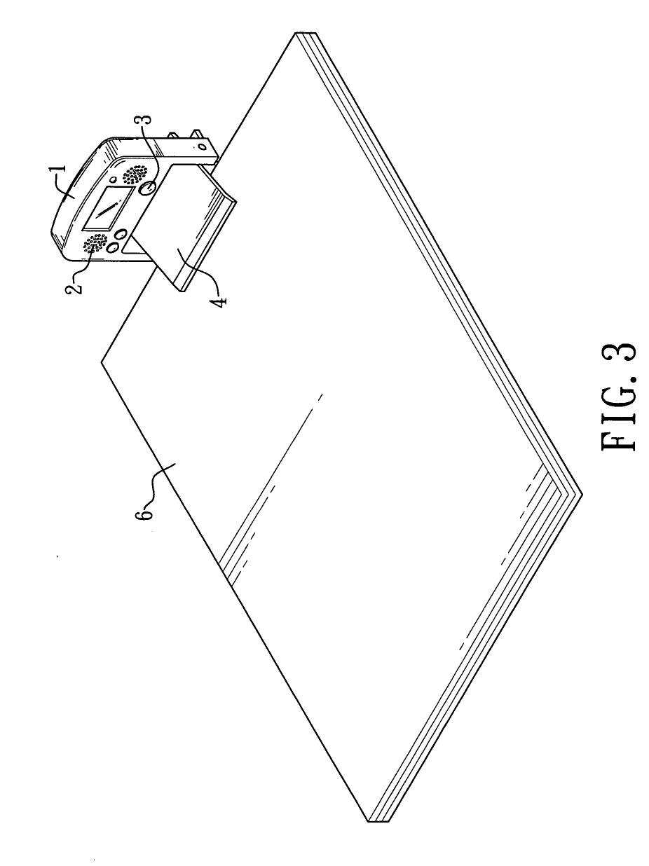

With such a device, a document transmitter may record the messages that he or she wants to leave to an intended document receiver with the recording unit 2. The messages are thus stored in the clamp type multimedia recorder of the present invention, preferably in storage means, such as electronic memory, which will further discussed. The multimedia recorder is then attached by the clamp 4 to the document 6 to be transmitted, as illustrated in FIG. 3. When the receiver gets the document 6, he or she may play back the messages recorded in the multimedia recorder with the audio device 3 and/or the display 5. Audio and/or video messages may then be broadcast and shown with the speaker 31 and the display 5.

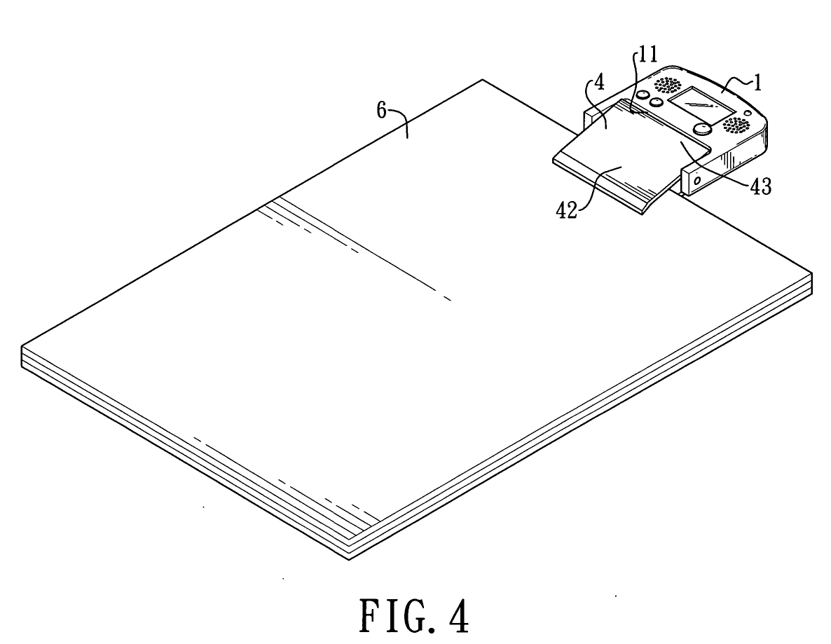

Due to the pivotal connection between the pivot pins 41 of the clamp 4 and the holes 12 of the main body 1, the main body 1 is rotatable with respect to the clamp 4 and is thus positionable at any desired orientation. For example, the main body 1 may be positioned to be substantially perpendicular to the clamp 4 as shown in FIG. 3, whereby when the clamp 4 engages a document 6, the main body 1 is substantially perpendicular to the document 6 and thus allowing for ready observation by a person. The main body 1 may also be substantially coplanar with the document 6, as illustrated in FIG. 4, wherein the manual operation means 43 of the clamp 4 is received in the recess 11 of the main body 1. This reduces the amount of space occupied by the device of the present invention during the transportation of the document 6.

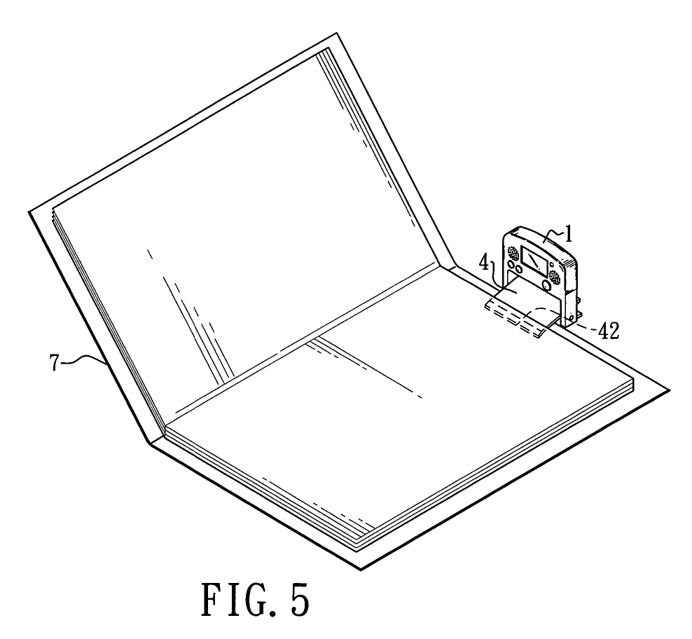

Also referring to FIG. 5, which shows an application of the multimedia recorder of the present invention, the multimedia recorder of the present invention is attached to a bottom cover of a document file or folder 7 in which a document to be transmitted is received. The clamping jaws 42 engage the bottom cover of the file 7. This allows a person to open the file 7 without being interfered with by the multimedia recorder.

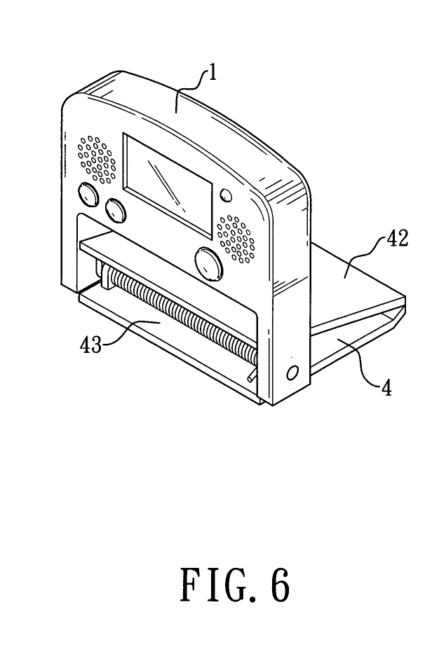

Referring to FIG. 6, another application of the present invention is shown, wherein the clamp 4 is rotated to such a position to serve as a base or a stand to support the main body 1 as a stand-along device.

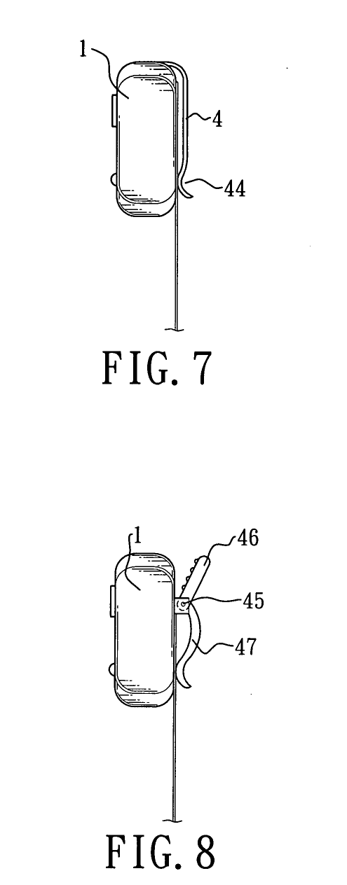

With reference to FIG. 7, which shows another embodiment of the multimedia recorder of the present invention, wherein a resilient clip 4 is attached to a rear side of the main body 1. The clip 4 is made of resilient material and has an engaging section 44 which is resiliently biased by the resiliency and shape of the clip 4 to engage the rear side of the body 4 whereby when a document is received between the clip 4 and the main body 1, the document is tightly clamped between the engaging section 44 and the rear side of the main body 1.

Referring to FIG. 8, a further embodiment of the multimedia recorder of the present invention is shown, wherein a clip 4 is rotatably attached to the rear side of the main body 1 by a pivot 45 and is biased by a spring (not shown) to have a clamping section 47 of the clip 4 engaging the rear side of the main body 1. Thus, a document can be securely attached to the main body 1 by being interposed between the clamping section 47 and the main body 1. The clip 4 also comprises a manual operation section 46, which allows a user to open the clip 4 by rotating the clip 4 against the biasing spring.

A camera may be selectively mounted to the main body 1 of the multimedia recorder of the present invention, which allows a user to make graphic messages or take pictures to be transmitted to a receiver. Such messages or pictures can be played back and shown by the audio device 3 and the display 5.

The multimedia recorder further comprises storage means, of which an example is a detachable external memory card having a USB (Universal Serial Bus) connection interface to convey the messages that are recorded in the recorder to for example a personal computer via a USB cable. Thus, valuable information/messages and pictures can thus be preserved in the computer. The messages that are recorded in the recorder can be repeatedly used, if desired, in the same or different devices or occasions and the messages may be subject to modifications. The interface also allows for downloading of audio/video messages from the personal computer to the multimedia recorder of the present invention. Further, if a wireless transmission system is incorporated, the messages can be transmitted to and played back in another recording/playing device. Examples of the wireless transmission system include infrared transmission, radio transmission and bluetooth techniques.

Although the present invention has been described with reference to the preferred embodiments thereof, it is apparent to those skilled in the art that a variety of modifications and changes may be made without departing from the scope of the present invention which is intended to be defined by the appended claims.

1. A multimedia recorder comprising a main body in which a recording unit and an audio device are incorporated and a clamp adapted to attach the main body to a document whereby the recording unit and the audio device record and play back a message left for the document.

2. The multimedia recorder as claimed in claim 1, wherein the main body comprising two space arms forming a recess therebetween to receive the clamp, the clamp comprising two pivot pins rotatably received in holes defined in the arms thereby rotatably attaching the clamp to the main body, the clamp comprising clamping jaws for clipping on the document and a manual operation section for opening/closing the jaws.

3. The multimedia recorder as claimed in claim 1, wherein the clamp comprises a resilient clip attached to a rear side of the main body, the clip comprising an engaging section resiliently biased to engage the rear side of the main body for tightly clamping a document therebetween.

4. The multimedia recorder as claimed in claim 1, wherein the clamp comprises a clip pivotally attached to a rear side of the main body and resiliently biased to have a clamping section engaging the rear side of the main body for tightly clamping a document therebetween, the clip also having a manual operation section to open/close the clamping section.

5. The multimedia recorder as claimed in claim 1, wherein main body comprises a display.

6. The multimedia recorder as claimed in claim 1, wherein the main body comprises a camera.

7. The multimedia recorder as claimed in claim 1, wherein the main body comprises storage means.

8. The multimedia recorder as claimed in claim 7, wherein the storage means comprises a detachable external memory card.

9. The multimedia recorder as claimed in claim 1, wherein the main body comprises a USB interface adapted to connect to and in communication with a personal computer for transmission of the messages to the computer.
